(19) United States
(12) Patent Application Publication
(10) Pub. No.: US 2005/0015357 A1
(43) Pub. Date: Jan. 20, 2005

(54) System and method for content development

(75) Inventor: Laleh Shahidi, Danville, CA (US)

Correspondence Address: MANATT PHELPS AND PHILLIPS;ROBERT D. BECKER, 1001 PAGE MILL ROAD, BUILDING 2, PALO ALTO, CA, 94304, US

(73) Assignee: Active Path Solutions, Inc.

(21) Appl. No.: 10/853,996

(22) Filed: May 21, 2004

Related U.S. Application Data
(60) Provisional application No. 60/472,538, filed on May 21, 2003.

(51) Int. Cl. G06F 7/00

(52) U.S. Cl. 707/1

(57) ABSTRACT

A system and method which provides capabilities for storing, reusing, modifying, sharing, delivering and tracking information or other content in an organized and effective manner in a shared operating environment is described. In particular, the invention provides an content developer based on an object-oriented information management system that improves and simplifies the process for storing, reusing, modifying, sharing, delivering and tracking information.

### CROSS-REFERENCE TO RELATED APPLICATIONS

This application claims priority to the U.S. provisional application entitled “Content Developer and Publisher,” Application No. 60/472,538, filed May 21, 2003, which is incorporated by reference herein.

### BACKGROUND OF THE INVENTION

The present invention relates to a system and method for content development. More particularly, the present invention relates to a system and method for storing, reusing, modifying, sharing, delivering and tracking information in an organized and effective manner.

The growth of Internet, intranet and the complexities involved in keeping web content up to date, have elevated the need for appropriate content authoring and management systems in organizations. Many of the solutions in this space are developed for computer savvy content producers like technical writers. Many enterprise busy yet casual content developers are frustrated with numerous web tools they have to use to organize their content that needs to be shared, reviewed, and published to the right place on their web site. They may be frustrated by the poor quality of the user interface, inflexible authoring process, lack of archiving, multi-version tracking, integration with other file types and desktop tools, and lack of opportunity to preview the content before publishing to web. Even the simple task of “pulling out obsolete content from the web site” becomes an unmanageable and impractical task, when the author and creation dates are all generically assigned and updated.

In application scenarios like research communities, content intensive institutions, like universities and legal firms, they are faced with an added problem and that is the management of related content objects among many teams, in diverse locations over a long period of time. Due to lack of standards in categorizing and profiling these content objects, oftentimes content produced by different people in different divisions of an organization are not readily accessible, reusable or aggregatable by a different content developer interested in consuming or accessing prior or existing work. This content at best is copied multiple times, in many physical locations, cut and paste from the original document with no traceability, archiving or proper search indexing.

Organizations generate value by sharing knowledge-based assets among employees, departments and even with other institutions. There is a need for simplified collaboration between team members working on multidimensional projects. Whether the project is constructing an e-learning course, managing drug discovery efforts, or establishing a harmonized marketing plan, it is crucial to provide an environment for team members to store, modify, and share information easily and efficiently.

There is a need for an information management system that permits collection, integration, and modification of different information in a platform that is easy to use for non-technical users.

### BRIEF DESCRIPTION OF THE DRAWINGS

FIG. 1 shows one embodiment of a network architecture of the present invention, including an end user with a workstation, an administrative user, and a server.

FIGS. 2-3 show one embodiment of a graphical user interface of the present invention, with selected fields utilized within the authoring means, including a dynamic structure editor, a workspace, and a repository.

FIG. 4 shows one example of components in different formats being compiled by a user and converted into a publishable format.

FIG. 5 shows one example of components being nested with other knowledge objects.

FIG. 6 shows one embodiment of a graphical user interface of the present invention, with selected fields utilized to identify source information and embedding standardized indexing labels to imported information.

FIG. 7. shows one embodiment of a flowchart of a method of the present invention.

FIG. 8. shows a structural diagram illustrating use of a knowledge object by multiple users.

### DETAILED DESCRIPTION OF THE INVENTION

The present invention provides integrated solutions for knowledge management. The present inventions provides a set of tools, techniques, and processes for the users of a specialized domain. These domains include research and development, strategic marketing, academic and corporate learning systems, and personnel management. By making research and communication tasks simple and structured, this invention helps organizations extract value from their intellectual assets. The present invention will be further described below.

The description that follows is presented to enable one skilled in the art to make and use the present invention, and is provided, in the context of a particular application and its requirements. Various modifications to the disclosed embodiments will be apparent to those skilled in the art, and the general principles discussed below may be applied to other embodiments and applications without departing from the scope and spirit of the invention. Therefore, the invention is not intended to be limited to the embodiments disclosed, but the invention is to be given the largest possible scope which is consistent with the principals and features described herein.

The present invention lets individual users manage information content in a variety of formats and allows customized solutions for creating, collecting, sharing or publishing sophisticated multimedia content. It also standardizes workflow processes across an organization, and helps managing collaborative efforts through merging, storing and protecting organizational knowledge in accessible and reusable forms.

The present invention provides intuitive extension of familiar office tools, adaptability to personal learning and work styles, customizable content and tools that simplify complex tasks, built-in information management expertise and wizards, organized work processes, and conceptual indexing. In other words, the present invention provides a flexible module that adapts to the work styles of individual users while addressing organizational needs for sharing and re-using expert knowledge.

The present invention is based on an object-oriented information management system which allows storing, reusing, modifying, sharing, delivering and tracking information in a much more organized and effective manner.

Adding more categorization and semantics to content objects leads to the evolution of content pieces towards “knowledge objects.” These knowledge objects are standard based and can be shared in an easy to use, collaborative, service oriented and integrated information technology environment. With the development of XML standards and software components that can interpret XML documents, the notion of structuring content, customizing it for a particular group of content contributors and consumers, reflecting the specifics of the application domain becomes possible for applications in fields such as pharmaceutical, manufacturing, and online universities. This allows for speed of user ramp up, ease of use, flexibility in defining the templates, sequencing of tasks, knowledge structure, and attaching meaningful values as actionable metadata tags.

The invention platform consists of a domain application and a server. The domain specific application is a desktop application that enables the mainstream user to manage information in a powerful, yet intuitive environment. An organizational backbone further empowers groups of users to collaborate on advanced projects with minimal implementation and management resources.

This invention is a cross-platform modular design that allows users to integrate various knowledge management solutions or software products, such as content, learning, or workgroup productivity packages. It is a document management and distribution module for storing, reusing, modifying, sharing, delivering and tracking knowledge objects that preserves knowledge components in an interactive format.

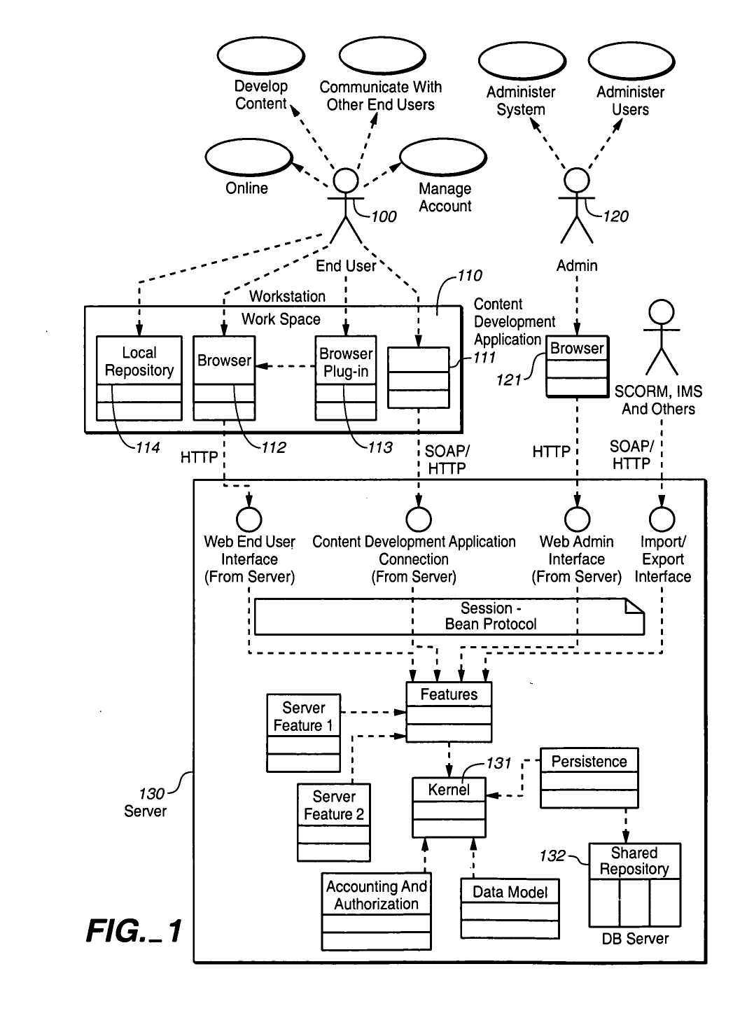

FIG. 1 shows one embodiment of a network architecture of the present invention, including a user 100 with a workstation 110, an administrator 120, and a server 130. Workstation 1 10 includes a content development application 1 11 which is connected to server 130. Workstation 110 may also include a browser 112 and a browser plug-in 113 to allow browser 112 to be integrated into content development application 111 and also to access server 130. Workstation 110 may also include a local repository 114. Administrator 120 may use a browser 121 to configure server 130. Server 130 includes a kernel and a shared repository 132.

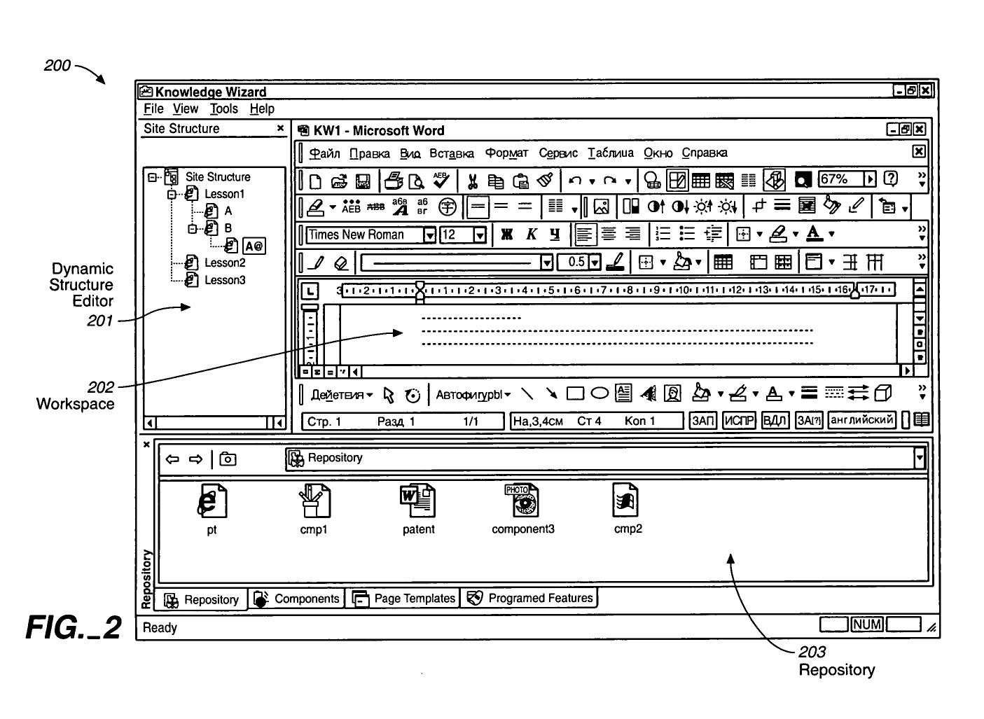

FIGS. 2-3 show one embodiment of a graphical user interface 200 of the present invention, with selected fields utilized within the authoring means, including a dynamic structure editor 201, a workspace 202, and a repository 203. Workspace 202 includes a list of data collected 204, a file browser 205, and editing information 206.

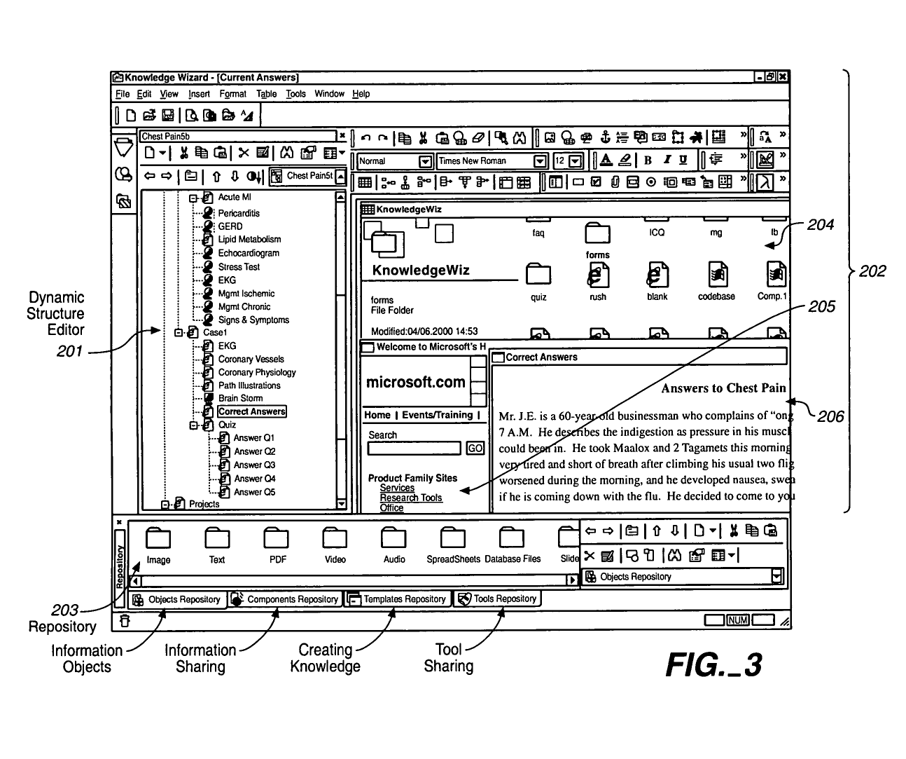

FIG. 4 shows one example of components in different formats being compiled by a user 100 and converted into a publishable format. The components are an HTML page 401, a Microsoft Excel document 402, a text document 403, a Microsoft Word document 404, and Adobe Acrobat PDF file 405. In this example, all of the components are converted into a common format, an HTML page 406.

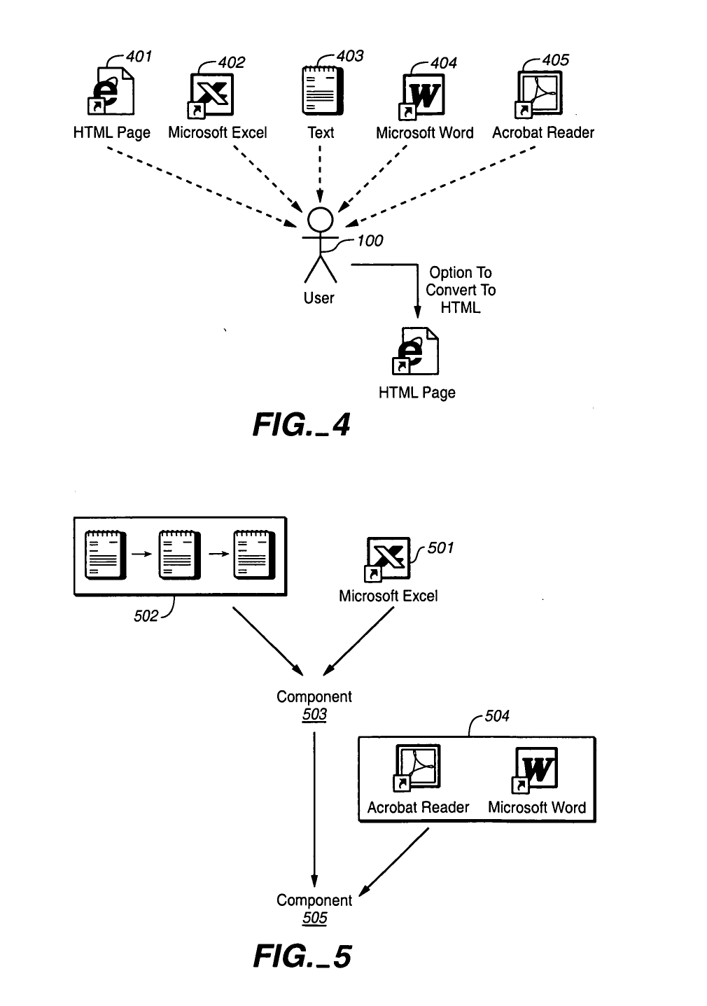

FIG. 5 shows one example of components being nested with other knowledge objects. Here, a Microsoft Excel component 501 is nested with several text file components 502 into a component 503. A component 504 includes an Adobe Acrobat component and a Microsoft Word component nested together. Components 503 and 504 are nested together into a component 505.

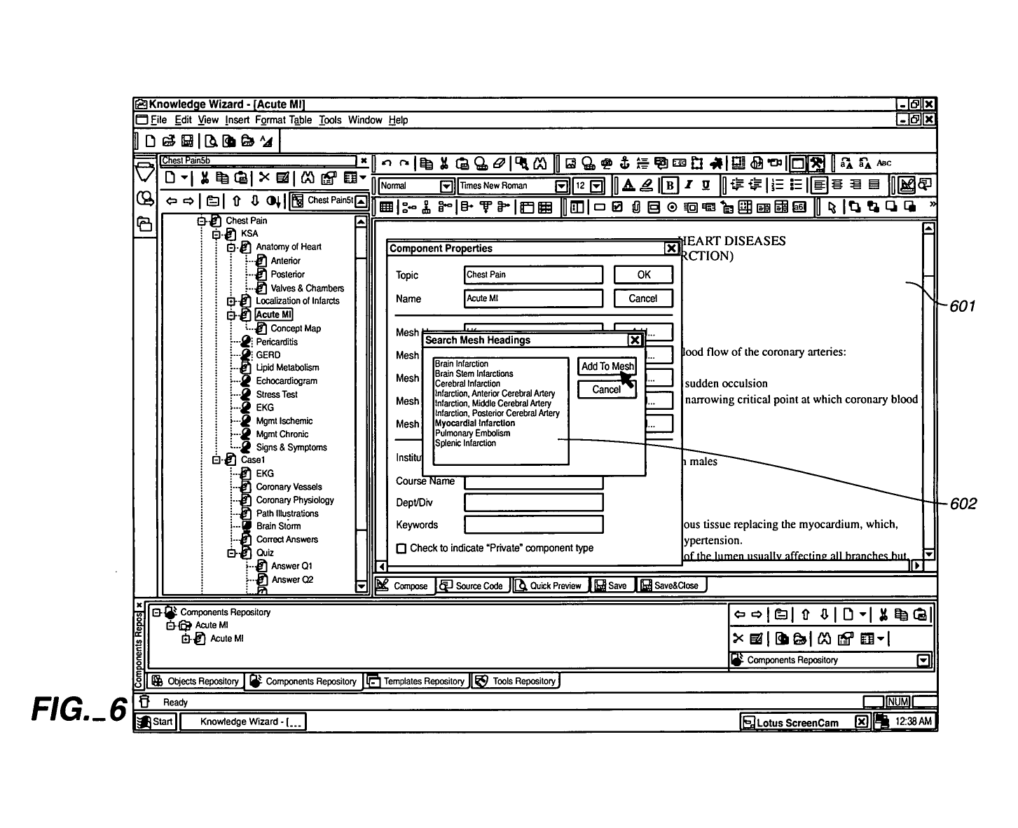

FIG. 6 shows one embodiment of a graphical user interface of the present invention, with selected fields utilized to identify source information 601 and embedding standardized indexing labels 602 to imported information.

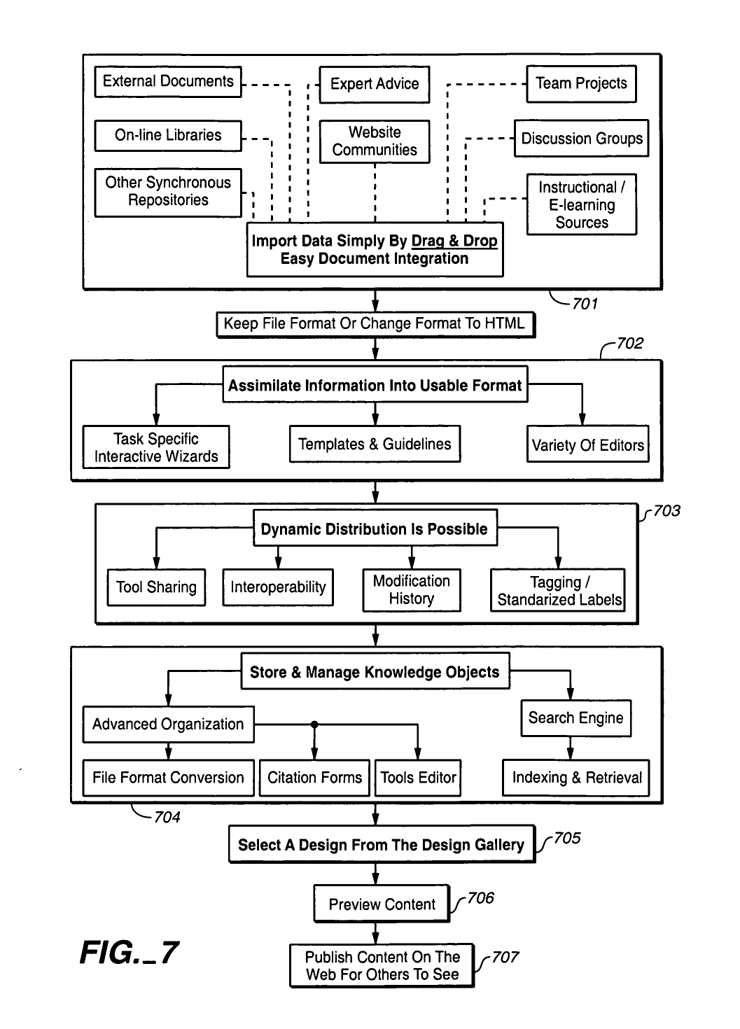

FIG. 7. shows one embodiment of a flowchart of a method of the present invention. In step 701, the user imports data from sources such as external documents, online libraries, other synchronous repositories, expert advice, website communities, team projects, discussion groups, instructional and e-learning sources, or any other suitable source. This data may be imported by drag-and-drop in the user interface. The imported data may be kept in its original data format, or changed to some other format such as HTML. In step 702, the information is assimilated into a usable format, using task-specific interactive wizards, templates and guidelines, a variety or editors, or any other suitable application. In step 703, dynamic distribution is made possible through tool sharing, interoperability, association of a modification history, association of tags or standardized labels, and other suitable methods. In step 704, the knowledge objects are stored and managed through file format conversion, citation forms, tools editor, or other suitable methods. This allows the knowledge objects to be retrieved by a search engine. In step 705, a design may be selected from a stock design gallery, or a user-created design may be used. In step 706, the content may be previewed. In step 707, the content may be published. The content may be viewed by others using a suitable application depending on the format the content is presented in. In this example, the format is HTML and the content is published in the form of a web page.

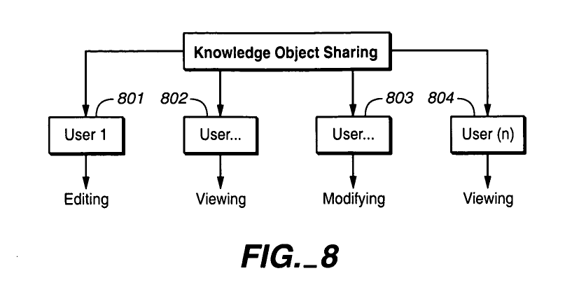

FIG. 8. shows a structural diagram illustrating use of a knowledge object by multiple users. Different knowledge objects may be simultaneously edited, viewed, modified, and viewed by different users 801, 802, 803, and 804 respectively.

### Software Overview

Architectural fundamentals of the present invention is presented as follows:

1. Knowledge objects are the building blocks of the content. Some examples of knowledge objects include: Raw File, HTML page, Folder, Design, and Wizard. Knowledge objects may be organized into a hierarchy. There are special rules on how such structures can be built and how knowledge object behavior changes depending on its position in the structure.

2. Repository is a centralized place where knowledge objects are stored. Repository is responsible for managing concurrent access to knowledge objects by multiple users. Repository tracks versions of knowledge objects.

3. Workspace is the place where knowledge object editing happens. Workspace can connect to one or more Repositories, making it possible for editing of knowledge objects.

4. Version Control is implemented using two primary mechanisms: 1) version identified, which helps to tell between different versions; 2) change history table, which helps to track changes made to an object. Repository and Workspace can track versions.

5. Servers store catalogs of Users, Groups and Official Entities.

6. User is a protected account representing an end-user login. Users differ in their rights with respect to Official Entities.

7. Profile is where user data are stored.

8. Groups are collections of users and other groups used to control access to server resources.

9. Server Policy is a file or another data structure that describes the policies of ruling resources allocation and other server activities. Server Policy is used to customize Servers for particular organization setting.

10. Official Entity represents a coarse-grained unit of resources provided by Servers.

11. Deployment is a process of publishing contents into a Repository.

12. Knowledge Objects Scripting: When knowledge objects are activated during run-time, they undergo server-side processing before being shown to the requester. The logic that defines the processing is specific for each type of knowledge objects. During run-time, knowledge objects can access Knowledge Objects' Run-Time Context to read and set data.

13. Knowledge Objects' Run-Time Context (KORTC) is a data model accessible by knowledge management in run-time.

14. Server Wide Searching is a feature that enables searching for knowledge objects. Searching is done using Index. Each server has one global Index. Index is updated automatically when objects are changed. Each type of knowledge object has its own indexing policy.

15. Repositories Synchronization is a process of intelligent transfer of Knowledge Objects from one Repository to another.

16. Visual Basic for Applications is an advanced technology, which makes the system of the present invention accessible from COM-aware scripting languages, such as Visual Basic, -much like MS Office products.

17. To better understand the present invention, it will be helpful to consider the following finctionalities:

### Content Development

The present invention allows one or a plurality of authors to import information and develop content in a shared environment.

A database management system may be used to control information sets. A database management system is an integrated, computer-based matrix of programs and information sets whose overall purpose is to record, store, maintain, systematize, and manipulate large collections of related data subsets. Data may be partitioned into interrelated databases that can be used interactively and cooperatively. A database management system may be used to access, create, maintain, and manipulate collections of data stored in the database system. Information may be stored in a hierarchy by: field (one piece of data about a person, place, object, or event), by record (a set of data items about a single person, place, object, or event), or by file or database (similar records about people places, objects, or events).

Some databases are hierarchical, which is to say each data subset is accessed by a “tree” of menus and therefore the user may have to return to the menu tree to access a different subset of data. Other databases are relational, meaning that information stored in the data matrix may be interconnected or linked into structured relationships while the actual data may reside in logical sub-segments. For example, a patient record, which contains demographic, laboratory and radiology data, may appear to the user to be a single dataset but may actually consist of three separate databases, each containing respectively demographic, laboratory, and radiology data, yet interconnected by links such as patient I.D. number.

The present invention is capable of using object-oriented databases. For example, in an object-oriented clinical database, all of a given patient information may be nested into a single collection or “object” of linked information, and the many different objects may be linked together so that data can be moved or transferred “en masse” from one system to another.

An object-oriented content model where all of a given information is nested into a single collection or “object” of linked information allows data to be moved or transferred “en masse” from one system to another. This allows the user to move content around very easily and efficiently by simply dragging and dropping objects into the desired application. This modular approach provides the possibility of using each component of the product independently based on need, size of operation, and budget constraints.

Parts of documents may be easily dragged and dropped into a platform may can be integrated into an “object” module. The present invention provides a dynamic environment and allows the author to easily move things around, and add or delete parts or all of certain documents.

The present invention also offers tools to easily assimilate information into usable knowledge, and to provide customizable content allowing selective and personalized storage, retrieval, assimilation and dissemination of knowledge objects for presentations, tutorials, discussions, and so on. Task-specific interactive wizards, templates, guidelines, and editors are all tools that work efficiently in this environment to facilitate assimilation of information into usable knowledge.

Built-in editors allow for creation of text, charts, images, graphs and concept maps, which also facilitate online collaboration and team working. Numerous wizards take the user through the steps of creating task specific business, administrative or instructional functions and minimizes the need for administrative, programming, and design support.

### Storage and Management of Information

Storing information in an organized manner can facilitate efficient retrieval and reuse of such information. There is tremendous amount of informational material that is developed by one person, modified by another and can be reused by other team members or users in different institutions. There is often a loss of productivity and duplication of effort due to lack of accessibility to information. Searching for a document can be a very time consuming project due to inadequate modification history tracking and an inadequate organization of information.

The present invention addresses the above issue with use of methods such as file format conversion, addition of citation forms, and addition of a tools editor. When a document is stored, the author may be given the option to change its format into HTML and the author may be prompted to provide information about the nature of the document so the system can index it appropriately. This improves information retrieval through an indexing and search engine.

### Dynamic Distribution

One important advantage of the present invention is to provide for easy collaboration by all team members involved in a development process. The present invention allows multiple users to work simultaneously with its components to perform separate tasks, and collaboratively update, transfer, and redesign information. This is possible by the interoperability among different institutions. The present invention links different applications and synchronizes various functions and it allows for integration between different users.

In other words, the present invention provides standardized interoperability and allows easy access and reuse of information through data labeling with standardized description. The present invention also provides a modification history stating the author, editor, and date of modification, and also by tagging (metadata)-standardized labels (SCROM).

When knowledge objects are shared between multiple users, modifications may be recognized and recorded to preserve copyright information about original authors. Knowledge objects may be identified before they are stored on the server by generating an interface prompting the user for source information, and automatically embeds standardized indexing labels to them. The metadata generation tool may connect to a nationally approved coding database, giving extensive search-engine capability to the data so that retrieving information is fast, easy, and efficient.

The present invention also allows the underlying database structure to adapt to specific environments so that knowledge objects contain the same vocabulary and terminology, facilitating a fast and more efficient searchable database. In other words, knowledge objects may be identified before they are stored on the server by generating an interface from that prompts the user for source information and automatically embeds standardized indexing labels to them. Users may then identify information and decide if it meets their needs before downloading knowledge objects.

### Presentation and Publication

The present invention provides automated launch of knowledge objects and presentation of contents. When a document is entered into the authoring portion, the author may be given the option to convert the document to an HTML file. The user may change the content into a publishable format at a touch of a button. This invention separates design from content and gives the author a chance to choose between a number of existing designs as easily as clicking on an acceptable design.

The present invention also allows the author to preview the content before publishing it on the web or on the internal network. Content alteration of previously published material can easily be done and this invention reduces or eliminates the need for a web-publishing software or a system administrator to perform this task.

This invention also provides for special partitioning for publishing projects and teamwork. The author can decide what information will be displayed for what users and what information should be hidden from others giving the author complete autonomy.

### Description of Operation

After uploading the software and running the program, the user will see the main user interface which may contain: an authoring module or workspace (for writing and developing, editing and viewing contents),a storing module or repository (for depositing the contents), and/or a publishing module (to present the contents). The user may view the contents and resources contained in any frame, open them for fast preview, or launch wizards that will guide them through task-oriented steps.

The authoring tool may have a modular architecture with drag-and-drop capability. The user starts a search and collects data from different resources. The researched material may be of any format (text, images, PDF, audiovisual files, etc.), and may come from any resources such as the Internet, local or global databases. This module allows users create and edit documents utilizing standard desktop publishing tools that can be dragged and dropped, and used in the platform.

This object-oriented system treats information as knowledge objects where all of a given information is nested into a single collection or “object” of linked information so that data can be moved or transferred “en masse” from one system to another. Contents may consist of a variety of forms presented in any format collectively nested into a single aggregate or “object”. This modular approach provides the possibility of using each component of the product independently based on need, size of operation, and budget constraints.

The authoring module allows the user to work off-line and may also contains interactive wizards to help the user follow a content hierarchy specific to the nature of their domain. The interactive wizard provides step-by-step instructions for the author to give title to the content being created, to create a structure for the content (introduction, body, conclusion), to evaluate the content, to select a design from the design gallery to be coupled with the content, to preview the content, and finally to publish it at the press of a button. An author who wishes to deviate from this structure, can disregard the wizard and develop the content as desired. The present invention gives the user complete flexibility, and wizards can be customized to the needs of different domains.

Task specific interactive wizards, templates, guidelines, and editors are all tools that may work in this object-oriented environment to facilitate assimilation of information into usable knowledge. Numerous wizards may take the user through the steps of creating task specific functions. Built-in editors may allow for creation of text, charts, images, graphs and concept maps, which facilitate online collaboration and team working.

The authoring module may also contain a workspace in which the user can bring in documents of different format from a variety of sources such as the internet, discussion groups, other team projects, and other synchronous interactions. In addition to text and graphics, the present invention may incorporate audio and video files, discussion forums and online conferencing capabilities. Any part of these documents may easily be dragged and dropped into a platform regardless of their format. This provides for fostering the dynamic exchange of ideas, thoughts, questions and answers.

The authoring module may also contain a dynamic structure editor that displays content in a hierarchical tree from general subjects to particular themes. The components may be organized, classified, indexed and searched by other team members who have access to view, modify or use the content. Multiple knowledge components may be aggregated into hierarchies of customizable information. Administrative functions may be established so other users can access, view, use or modify the structure for team projects or to achieve desired outcomes.

Knowledge contents may be dragged, dropped, and stored from any source into a repository, at which point, a local searchable database may be created and uploaded to a server so other users may access it. In other words, this provides a dynamic environment where knowledge components are updated and shared with others and the repository acts as a relevant library of resources that can be shares between different users. Knowledge objects are stored and displayed as text files or icons showing their format. Contents may consist of a variety of forms and can be presented in any format. Each object can be opened by double clicking on the icon and the contents will appear in the Working Area for review or modification regardless of their format. These icons can also be dragged onto the users' desktop. Every time a document is being stored, the author is given the option to change its format into HTML and the author is also required to provide information about the nature of the document so the system can index it appropriately. This improves information retrieval by extensive indexing and search engine.

Knowledge objects may be easily shared. Multiple users can simultaneously work with knowledge objects or its components performing separate tasks, and collaboratively updating, transferring, and redesigning information. Different applications may be linked and various functions synchronized and complete integration between different users is possible. The tool repository may contain other software and communication tools. Depending on the user's needs, third-party tools may be dragged and dropped into the pages to be used.

Design is separated from content and the author can choose a design from the design gallery by simply clicking on an acceptable design. The content may be previewed in browser mode and allows author to make changes if not satisfied with the presentation of content.

If the preview is satisfactory, the content is ready to be uploaded. Before knowledge objects are stored on the server, an interface may prompt the user for source information and may automatically embed standardized indexing labels to them. The metadata generation tool may connect to a nationally approved coding database giving extensive search engine capabilities. Users may identify information and decide if it meets their needs before downloading knowledge objects.

The contents may then be published on the user's web browser of choice, on a CD-ROM or printed on paper.

### EXAMPLE 1

Bioscience research and development requires extensive documentation. The research process requires involvement of a number of different agencies and multiple team members within the agencies responsible for collecting research data from remote areas, communicating such data from different regions or departments to one central place for analysis, modification, and reporting data. Launch of a new drug requires intense collaboration with researchers, partners, regulatory agencies and others. Competition is fierce in these industries and product development process is usually very lengthy. Inefficient drug development cycle can negatively impact drug prices. Therefore, the first mover advantage is critical.

The present invention meets the above mentioned challenges by facilitating recording, storing and retrieving data efficiently, expediting the electronic flow of information, and enabling secure cross functional collaboration. This allows the manufacturers to bring products to the market faster, providing an opportunity for more competitive pricing and greater potential for revenue.

It enhances the traditional processes by allowing collection, manipulation, and publishing of material from many different sources (including multimedia, laboratory instrument traces, text, tables, databases, and scanned images). Files are decomposed into knowledge objects and repositories are restructured based on knowledge objects.

The present invention allows users access to internal, as well as standard libraries and glossaries and launch of third-party applications within the invention environment. Knowledge objects are tagged for reuse, sharing, reference materials, source information, change history, and authorization levels.

The present invention also provides wizard guides for preparing specialized reports (such as FDA applications), patent applications, conference proceedings, compliance and management reports.

### EXAMPLE 2

Marketing efforts in organizations also require extensive documentation of market research, product research, and personnel training. Launch of a new product requires collaboration with manufacturers, retailers, and others. An effective system to facilitate recording, storing and retrieving data, and efficient collaboration will provide an opportunity for more competitive pricing and greater potential for revenue.

The present invention enhances the traditional processes by allowing collection, manipulation, and publishing of material from many different sources (including multimedia, text, tables, databases, and scanned images). Files are decomposed into knowledge objects and repositories are restructured based on knowledge objects.

This invention allows users access to internal, as well as standard libraries and glossaries and launch of third-party applications within the invention environment. Knowledge objects are tagged for reuse, sharing, reference materials, source information, change history, and authorization levels.

The present invention also provides wizard guides for preparing specialized reports, conference proceedings, management reports, competitive landscaping, proposals, product information and comparisons.

### EXAMPLE 3

E-learning is a growing industry and it is also being used in companies to train and evaluate employees. An effective program to simplify authoring a course or a job description provides a cost effective alternative for teaching classes and a potential for greater revenue.

The present invention provides authoring tools automates the process of creating and publishing a course on the web or on a network.

The contents of the course are created by the instructor and the course can be remotely accessed by students. The program has capability to collect and store data and information of all student activities, quizzes and exams.

The present invention enhances the traditional processes by allowing collection, manipulation, and publishing of material from many different sources (including multimedia, text, tables, databases, and scanned images). Files are decomposed into knowledge objects and repositories are restructured based on knowledge objects.

The present invention allows users access to internal, as well as standard libraries and glossaries and launch of third-party applications within the invention environment. Knowledge objects are tagged for reuse, sharing, reference materials, source information, change history, and authorization levels.

The present invention also provides wizard guides for preparing quizzes, exams, and discussion groups.

1. A method for content development, comprising:
collecting data;
using the data to create one or more knowledge objects; and
using one or more knowledge objects to generate a presentation.

2. The method of claim 1, wherein the data is a web page.

3. The method of claim 1, wherein the data is a word processing document.

4. The method of claim 1, wherein the data is an audio-video file.

5. The method of claim 1, wherein using the data to create knowledge objects includes parsing the data into a plurality of components.

6. The method of claim 1, wherein using the data to create knowledge objects includes converting the data to a common format.

7. The method of claim 6, wherein the common format is HTML.

8. The method of claim 1, wherein the presentation includes a structure.

9. The method of claim 1, wherein the presentation includes a predefined template.

10. The method of claim 1, wherein the presentation is a web page.

11. The method of claim 1, wherein the presentation is a word processing document.

12. The method of claim 1, wherein the presentation is a slideshow.

13. The method of claim 1, further comprising:
attaching associated data to one or more knowledge objects.

14. The method of claim 13, wherein the associated data includes source information.

15. The method of claim 13, wherein the associated data includes a change history.

16. The method of claim 13, wherein the associated data includes an authorization level.

17. The method of claim 1, further comprising:
sharing the knowledge objects with one or more users.

18. A system for content development, comprising:
means for collecting data;
means for creating one or more knowledge objects from the data; and
means for generating a presentation from one or more knowledge objects.

19. The method of claim 18, wherein the means for creating one or more knowledge objects from the data includes means for parsing the data into a plurality of components.

20. The method of claim 18, wherein the means for creating one or more knowledge objects from the data includes means for converting the data to a common format.

21. The method of claim 18, further comprising:
means for attaching associated data to one or more knowledge objects.

22. The method of claim 18, further comprising:
means for storing and sharing the knowledge objects with one or more users.

23. A system for content development, comprising:
a content developer application for finding and collecting data;
a knowledge-maker engine for creating one or more knowledge objects from the data; and
a presentation generation engine for generating a presentation from one or more knowledge objects.

24. The method of claim 23, further comprising:
a repository for storing and sharing the knowledge objects with one or more users.
